(19) United States
(12) Patent Application Publication
(10) Pub. No.: US 2022/0141645 A1
(43) Pub. Date: May 5, 2022

(54) METHOD AND DEVICE FOR MANAGING COMMUNICATION BUNDLE OF SMART SECURE PLATFORM

(71) Applicant: Samsung Electronics Co., Ltd., Suwon-si (KR)

(72) Inventors: Jonghoe KOO, Suwon-si (KR); Kangjin YOON, Suwon-si (KR); Duckey LEE, Suwon-si (KR); Sujung KANG, Suwon-si (KR); Taehyung LIM, Suwon-si (KR)

(21) Appl. No.: 17/453,116

(22) Filed: Nov. 1, 2021

(30) Foreign Application Priority Data
Nov. 2, 2020 (KR) 10-2020-0144503

(51) Int. Cl. H04W 8/18; H04W 8/22

(52) U.S. Cl. CPC H04W 8/183; H04W 8/22

(57) ABSTRACT

The disclosure relates to a communication technique for convergence between an IoT technology and a 5G communication system for supporting a higher data transmission rate than a 4G system, and a system thereof. The disclosure may apply to intelligence services on the basis of a 5G communication technology and an IoT-related technology. The disclosure may apply to a technology of managing connection between a terminal supporting multiple SIMS and multiple activated telecom bundles, the terminal including a smart secure platform mounted therein. The method comprises enabling a first telecom bundle of a plurality of telecom bundles of the smart secure platform, generating a first pipe for a communication between the activated first commutation bundle and a modem of the terminal, and mapping the generated first pipe to a first SIM port of a plurality of SIM ports of the modem, based on an identifier of the first SIM port.

### CROSS-REFERENCE TO RELATED APPLICATIONS

This application is based on and claims priority under 35 U. S.C. § 119 to Korean Patent Application No. 10-2020-0144503, filed on Nov. 2, 2020, in the Korean Intellectual Property Office, the disclosure of which is herein incorporated by reference in its entirety.

### BACKGROUND

### 1. Field

The disclosure relates to a smart secure platform and, more specifically, to a method and a device for managing a communication bundle (telecom bundle) of the smart secure platform.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a “Beyond 4G Network” communication system or a “Post LTE” system. The 5G communication system is considered to be implemented in higher frequency (mmWave) bands (e.g., 60 GHz bands) so as to accomplish higher data rates. To decrease propagation loss of the radio waves and increase the transmission distance, beamforming, massive multiple-input multiple-output (MIMO), full dimensional MIMO (FD-MIMO), array antenna, analog beam forming, large scale antenna techniques are discussed in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid FSK and QAM modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (RAN) as the above-described big data processing technology may also be considered an example of convergence of the 5G technology with the IoT technology.

In addition, a multi-SIM terminal enabling access via multiple networks in a commutation terminal is common. A modem of the multi-SIM terminal may simultaneously support network access of a mobile network operator by using multiple subscriber identify modules (SIMs) or universal subscriber identify modules, and provide a user with an enhanced user experience. For example, one SIM may be used for calls only, and another SIM may be used for data communication only. When traveling over countries/regions, an optimized mobile communication service maybe provided using various SIMs instead of using a roaming service.

The multi-SIM terminal may be equipped with multiple universal integrated circuit cards (UICCs) or embedded UICCs (eUICCs). Alternatively, in a case of a smart secure platform (SSP) terminal, multiple telecom bundles may be activated so that the multi-SIM can be supported.

Accordingly, there are various technical issues and rooms for improvement for multiple telecom bundles installed in multiple UICCs, eUICCs, or SSPs, a multi-SIM terminal, and a modem of the multi-SIM terminal, and research related thereto is actively being undertaken.

### SUMMARY

The disclosure provides a method for activating/enabling a telecom bundle (communication bundle) included in a terminal and connecting the activated bundle to a modem.

The disclosure provides a method for activating and connecting multiple telecom bundles installed in an SSP terminal in consideration of a function of a multi-SIM modem.

In accordance with an aspect of the disclosure, a method of a terminal comprising a smart secure platform is provided. The method comprises enabling a first telecom bundle of a plurality of telecom bundles of the smart secure platform; generating a first pipe for a communication between the activated first commutation bundle and a modem of the terminal; and mapping the generated first pipe to a first subscriber identity module (SIM) port of a plurality of SIM ports of the modem, based on an identifier of the first SIM port, wherein the first SIM port is associated with a first baseband.

In an embodiment, wherein the enabling comprises transmitting, by a local bundle assistant (LBA) of the terminal, a bundle enablement command comprising an identifier of the first telecom bundle to a secondary platform bundle load (SPBL) of the smart secure platform.

In an embodiment, wherein the mapping comprises transmitting, by the LBA, a mapping request for mapping the generated first pipe to the first SIM port to the modem, wherein the mapping request comprises the identifier of the first SIM port and an identifier of the first pipe.

In an embodiment, wherein the bundle enablement command further comprises the identifier of the identifier of the first SIM port, and wherein the mapping comprises transmitting, by the SPBL, a mapping request for mapping the generated first pipe to the first SIM port to the modem.

In an embodiment, wherein the first pipe is generated between a gate of the enabled first telecom bundle and a gate of the modem, according to a predetermined scheme.

In an embodiment, wherein the gate of the modem is connected only to the first baseband.

In an embodiment, wherein a second pipe is further generated between a gate of a second telecom bundle of the smart secure platform and a second gate of the modem different from the gate connected to the first baseband.

In an embodiment, wherein the gate of the modem is connected to a plurality of basebands comprising the first baseband through a multiplexer, each of the plurality of basebands being associated with a single SIM port.

In an embodiment, wherein a second pipe is further generated between a gate of a second telecom bundle of the smart secure platform and the gate of the modem connected to the first baseband.

In an embodiment, wherein the pipe is an application protocol data unit (APDU) for an APDU communication.

In an embodiment, wherein the gate of first telecom bundle is a universal integrated circuit card (UICC) service gate and the gate of modem is an UICC application gate.

In accordance with another aspect of the disclosure, a terminal comprising a smart secure platform is provided. The terminal comprises a transceiver; and a controller connected to the transceiver, wherein the controller is configured to control to: enable a first telecom bundle of a plurality of telecom bundles of the smart secure platform; generate a first pipe for a communication between the activated first commutation bundle and a modem of the terminal; and map the generated first pipe to a first subscriber identity module (SIM) port of a plurality of SIM ports of the modem, based on an identifier of the first SIM port, wherein the first SIM port is associated with a first baseband.

In an embodiment, wherein the controller is further configured to control to: transmit, by a local bundle assistant (LBA) of the terminal, a bundle enablement command comprising an identifier of the first telecom bundle to a secondary platform bundle load (SPBL) of the smart secure platform.

In an embodiment, wherein the controller is further configured to control to: transmitting, by the LBA, a mapping request for mapping the generated first pipe to the first SIM port to the modem, wherein the mapping request comprises the identifier of the first SIM port and an identifier of the first pipe.

In an embodiment, wherein the bundle enablement command further comprises the identifier of the identifier of the first SIM port, and wherein the controller is further configured to control to: transmitting, by the SPBL, a mapping request for mapping the generated first pipe to the first SIM port to the modem.

In an embodiment, wherein the first pipe is generated between a gate of the enabled first telecom bundle and a gate of the modem, according to a predetermined scheme.

In an embodiment, wherein the gate of the modem is connected only to the first baseband, and wherein a second pipe is further generated between a gate of a second telecom bundle of the smart secure platform and a second gate of the modem different from the gate connected to the first baseband.

In an embodiment, wherein the gate of the modem is connected to a plurality of basebands comprising the first baseband through a multiplexer, each of the plurality of basebands being associated with a single SIM port, and wherein a second pipe is further generated between a gate of a second telecom bundle of the smart secure platform and the gate of the modem connected to the first baseband.

In an embodiment, wherein the pipe is an application protocol data unit (APDU) for an APDU communication.

In an embodiment, wherein the gate of first telecom bundle is a universal integrated circuit card (UICC) service gate and the gate of modem is an UICC application gate.

In addition, in order to support a multiple SIMS in the SSP terminal, the disclosure provides a method for managing an integrated SIM (iSIM) port, a pipe, and a gate of a modem of an SSP terminal to activate multiple telecom bundles, through described embodiments.

A method of the disclosure according to an illustrative embodiment includes: activating a telecom bundle installed in the SSP upon a user's request, wherein the activating of the telecom bundle includes identifying an iSIM port and a telecom bundle to be activated upon the user's request; activating a telecom bundle by using the identified telecom bundle identifier and the iSIM port identifier; and connecting the activated telecom bundle to a specific SIM port.

In addition, connecting of a modem to a telecom bundle of the disclosure according to an illustrative embodiment includes: connecting a modem and a telecom bundle according to an identifier of an iSIM port and an identifier of a pipe connected between the telecom bundle and the modem; or connecting a modem and a telecom bundle according to an iSIM port identifier of a modem and an identifier of a gate used to form a pipe between the telecom bundle and the modem.

According to various embodiments of the disclosure, a method of a terminal including a smart secure platform may include: activating a first telecom bundle of the smart secure platform; forming a first APDU pipe between the activated first telecom bundle and a modem of the terminal; and mapping the formed first APDU pipe to the first SIM port of the modem, wherein the first SIM port is associated with a first logical baseband.

According to various embodiments of the disclosure, a terminal including a smart secure platform may include: a transceiver; and a controller connected to the transceiver, wherein the controller is configured to: activate a first telecom bundle of the smart secure platform; form a first APDU pipe between the activated first telecom bundle and a modem of the terminal; and map the formed first APDU pipe to a first SIM port of the modem, and the first SIM port is associated with a first logical baseband.

In an embodiment, the activation may include transmitting, to the smart secure platform, a bundle activation command including an identifier of the first telecom bundle.

In an embodiment, the bundle activation command may be transmitted from a local bundle assistant (LBA) of the terminal to a secondary platform bundle loader (SPBL) of the smart secure platform.

In an embodiment, the bundle activation command may further includer an identifier of the first SIM port.

In an embodiment, the mapping may include transmitting, to the modem, a mapping request for mapping the formed first APDU pipe to a first SIM port of the modem, wherein the mapping request includes an identifier of the first SIM port.

In an embodiment, the mapping request may be transmitted from the LBA of the terminal to the modem, or may be transmitted from the SPBL of the smart secure platform to the modem.

In an embodiment, the mapping request may further include an identifier of the first APDU pipe.

In an embodiment, the first APDU pipe may be formed between a gate of the activated first telecom bundle and a gate of the modem according to a predetermined scheme.

In an embodiment, the modem may include a multiplexer connected to the gate of the modem, and a second APDU pipe may be formed between a gate of the modem and a gate of a second telecom bundle of the smart secure platform, the second telecom bundle being different from the first telecom bundle.

The technical subjects pursued in the disclosure may not be limited to the above mentioned technical subjects, and other technical subjects which are not mentioned may be clearly understood, through the following descriptions, by those skilled in the art to which the disclosure pertains.

According to the disclosure, a terminal can activate a telecom bundle in a specific iSIM port of a multi-SIM modem. Accordingly, even though multiple logical basebands of the multi-SIM modem have different radio access capabilities, the activated telecom bundle can be connected to a logical baseband corresponding to a user's request and used.

In addition, according to the disclosure, when the maximum simultaneously acceptable number of telecom bundles of a multi-SIM modem exceeds, a pipe is not formed, and thus the activated telecom bundle is not connected to a logical baseband, whereby failure in mobile communication network access can be prevented.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates an interface between an element and an internal element of an SSP terminal according to various embodiments of the present disclosure;

FIG. 2 illustrates a terminal internal or external element for downloading a bundle by an SSP terminal according to various embodiments of the present disclosure;

FIG. 3 illustrates example of an eUICC terminal according to various embodiments of the present disclosure;

FIG. 4 illustrates example of an iSSP terminal according to various embodiments of the present disclosure;

FIG. 5 illustrates example of an interface for APDU communication between a modem and a telecom bundle according to various embodiments of the present disclosure;

FIG. 6 illustrates example in which hosts in an iSSP generate a pipe through a gate according to various embodiment of the present disclosure;

FIG. 7A illustrates example of a multi-SIM modem of a terminal and a state in which multiple telecom bundles in an iSSP are connected to iSIM ports, respectively, according to various embodiments of the present disclosure;

FIG. 7B illustrates example of a multi-SIM modem of a terminal and a state in which multiple telecom bundles in an iSSP are connected to iSIM ports, respectively, according to various embodiments of the present disclosure;

FIG. 8 illustrates an example of forming a pipe for communication between a modem host and a telecom bundle according to various embodiments of the present disclosure;

FIG. 9A illustrates an example in which multiple telecom bundles are activated in a multi-SIM modem and connected to iSIM ports according to various embodiments of the present disclosure;

FIG. 9B illustrates another example in which multiple telecom bundles are activated in a multi-SIM modem and connected to iSIM ports according to various embodiments of the present disclosure;

FIG. 10 illustrates an example of a process of activating two telecom bundles upon a user request and allocating two telecom bundles to two SIM ports of a modem, respectively, according to various embodiments of the present disclosure;

FIG. 11 illustrates another example of a process of activating two telecom bundles upon a user request and allocating two telecom bundles to two SIM ports of a modem, respectively, according to various embodiments of the present disclosure;

FIG. 12 illustrates a structure of a terminal according to various embodiments of the present disclosure;

FIG. 13 illustrates a structure of a smart secure platform according to various embodiments of the present disclosure; and

FIG. 14 illustrates a flowchart of a method for a smart secure platform or a terminal according to various embodiments of the present disclosure.

### DETAILED DESCRIPTION

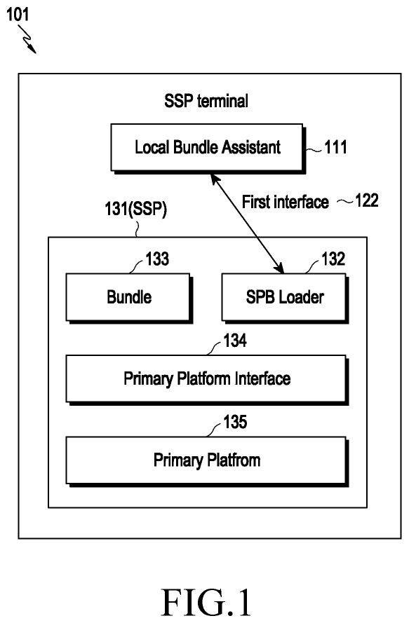

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, obj ect-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Further, the “unit” in the embodiments may include one or more processors.

The disclosure relates to a method and a device for activating a telecom bundle in a terminal including a smart secure platform and a modem supporting a multi-SIM function, and connecting the activated telecom bundle to the modem. More specifically, the disclosure relates to a method for connecting the activated telecom bundle to a specific SIM port of the modem to access a network by using a specific logical base band in the modem.

The disclosure provides a method for activating a telecom bundle (telecom bundle) included (installed) in an SSP terminal and connecting the activated bundle to a modem according to an illustrative embodiment. Specifically, the disclosure provides a method for specifying, when a modem supports multiple SIMs, a specific port among multiple ports and activating a telecom bundle.

In addition, the disclosure is to activate a specific bundle upon a user's demand and allow access to a network by using a specific radio access technology when multiple basebands to a modem supporting multiple SIMs have different radio access technology (RAT) capabilities.

A terminal modem having the conventional UICC, embedded UICC (eUICC), and the like mounted therein is connected to the UICC or the eUICC through an ISO 7816-3 interface. However, like an integrated SSP or an integrated eUICC, when a security medium is embedded in a communication processor (CP) system-on-chip (SoC), the modem and the communication security medium cannot be connected through the ISO 7816-3 interface, and thus a technology different from the existing technology is required.

The disclosure provides a technology based on a host controller interface (HCI) which may be an interface between a security medium and a modem of the integrated SSP or the eUICC terminal.

Specific terms used in the description below are provided to assist in the understanding of the disclosure, the use of the specific terms may be changed to a different form within a range without departing from the technical idea of the disclosure.

Security medium (SE, eSE, UICC, eUICC, SSP)

In the present disclosure, a secure element (SE) means a security module including a single chip which can store security information (e.g., a mobile communication network access key, user identify identification information such as an identification card/passport, credit card information, an encryption key, etc.), and mount and manage a control module (e.g., a network access control module such as a universal subscriber identity module (USIM), an encryption module, a key generation module, etc.) using the stored security information. The SE may be used for various electronic devices (e.g., a smartphone, a tablet PC, a wearable device, a vehicle, an IoT device, etc.), and provide a security service (e.g., mobile communication network access, payment, user authentication, etc.) through the security information and the control module. The SE may be used as a term collectively referring to a universal integrated circuit card (UICC), an embedded secure element (eSE), and a smart secure platform (SSP) into which the UICC and the eSE are integrated, and may be divided into a removable SE, an embedded SE, and an integrated SE which is integrated into a specific element or a system on chip (SoC), according to a form in which the SE is connected to or installed in the electronic device.

In the present disclosure, the eSE means an embedded SE which is fixed to the electronic device and used. Normally, the eSE may be manufactured for a manufacturer only upon a terminal manufacturer's request, and may be manufactured to include an operation system and a framework. The eSE may remotely download and install an applet-type service control module, and may be used for various security services such as an electronic wallet, ticketing, an electronic passport, and a digital key. In the disclosure, an SE in the form of a single chip attached to an electronic device, the SE capable of remotely downloading and installing a service control module, is referred to as an eSE.

In the present disclosure, a universal integrated circuit card refers to a smart card inserted into and used in a mobile communication terminal or the like, and may be called a “UICC.” The UICC may include an access control module for accessing the network of a mobile network operator. Examples of the connection control module include a USIM, a subscriber identity module (SIM), and an IP multimedia service identity module (ISIM). A UICC including a USIM is generally referred to as a USIM card. Likewise, a UICC including a SIM module is generally referred to as a SIM card. The SIM module may be mounted when a UICC is manufactured, or the SIM module of a mobile communication service that a user desires to use at the desired time may be downloaded in the UICC. The UICC may also download and install multiple SIMs, and may select and use at least one of the multiple SIMs. The UICC may be fixed to the terminal and used or may be used in a removable form, according to a chip form (form factor).

A UICC embedded in the terminal as a chip and used is referred to as an embedded UICC (eUICC), and particularly, a UICC embedded in an SoC including a communication processor, an application processor, or a single processor which is an integration of the above two processors may also be referred to as an integrated UICC (iUICC). Normally, an eUICC and an iUICC may be fixed to and used in a terminal, and accessing a network service of a mobile network operator is possible by remotely downloading a SIM module in the eUICC or the iUICC. The eUICC or the iUICC may be launched with a specific SIM module embedded therein at the time of manufacturing, and may be embedded int a terminal. A software package of SIM module information which is downloaded in the eUICC and used and authentication information for receiving a network service and information included in a USIM application may be collectively called an eUICC profile. The eUICC profile may be called an eSIM profile, an iUICC profile, or a USIM profile, or may be more simply called a profile.

In the present disclosure, a smart secure platform is a security module capable of integrally supporting the functions of an UICC and an eSE in a single chip, and may be simply referred to as an “SSP.” The SSP may be classified into a removable SSP (rSSP), an embedded SSP (eSSP), and an integrated SSP (iSSP) embedded in a system on chip (SoC). An SSP may include one primary platform (PP) and at least one secondary platform bundle (SPB) that operates on the PP. The primary platform may include at least one of a hardware platform and a low-level operating system (LLOS), and the secondary platform bundle may include at least one of a high-level operating system (HLOS) and an application that operates on the HLOS.

In the present disclosure, the secondary platform bundle (SPB) is driven on the primary platform (PP) by using a resource of the PP, and for example, the UICC bundle may mean a software package of an application, a file system, an authentication key value, and the like, stored in the existing UICC and a high-level operating system (HLOS) operating the of the application, file system, authentication key value, and the like, stored in the existing UICC.

In the present disclosure, the “secondary platform bundle” may be referred to as a “bundle.” The secondary platform bundle is simply called a bundle. The bundle may access a resource in a central processing device, a memory, and the like of a primary platform through a primary platform interface (PPI), and accordingly, may be operated on the primary platform. The bundle may be embedded in a communication application such as a subscriber identification module (SIM), a universal SIM (USIN), and an IP multimedia SIM (ISIM), and may be embedded in various applications such as an electronic wallet, ticketing, an electronic passport, and a digital key.

The SSP may be used for the above-described UICC or eSE according to bundles remotely downloaded and installed, and may be interchangeably used for the UICC and the eSE by installing multiple bundles in a single SSP and simultaneously operating the multiple bundles. In other words, when a bundle including a profile operates in an SSP, the SSP may be used for UICCs to access the network of a mobile operator. The corresponding UICC bundle may operate by remotely downloading at least one profile into the bundle and select and operate one of the remotely-downloaded at least one profile, as in an eUICC or an iUICC.

In addition, when a bundle including a service control module equipped with an application capable of providing a service such as an electronic wallet, ticketing, an electronic passport, or a digital key operates on the SSP, the SSP may be used for eSEs. Multiple service control modules may be integrally installed and operated in one bundle, or may be installed and operated in independent bundles. The SSP may be used by downloading and installing a bundle to be operated on the SSP in an external bundle management server (secondary platform bundle manager (SPB manager)) by using over-the-air (OTA) technology. A method of downloading and installing a bundle by using an OTA technology in an SSP is equally applicable to a removable SSP (rSSP) detachably inserted into a terminal, an embedded SSP (eSSP) installed in a terminal, and an integrated SSP (iSSP) included in a SoC installed in a terminal.

In the present disclosure, a telecom bundle may be a bundle which has at least one network access application (NAA) embedded therein, or has a function of capable of remotely downloading and installing at least one NAA, embedded therein. The NAA is a module for accessing a network stored in a UICC, and may be a USIM or an ISIM. The telecom bundle may include a telecom family identifier referring to a telecom family.

In the present disclosure, an eSIM bundle may be a bundle which has an eUICC OS driven therein and performs the same function as the eUICC so as to install a profile in a terminal to operate a network service. In the disclosure, the eSIM bundle may include a telecom family identifier referring to the eSIM bundle. The eSIM bundle may be refer to the UICC bundle.

In the present disclosure, a secondary platform bundle loader (SPBL) may refer to a management bundle for installing another bundle in the SSP and managing activation, deactivation, and deletion. In the disclosure, the secondary platform bundle loader may be simply referred to as a loader. A local bundle assistant (LBA) of a terminal or a remote server may install, activate, deactivate, and delete a specific bundle through the loader. In the disclosure, the loader may be also referred to as an SSP.

Terminal and local bundle assistant (LBA)

In the present disclosure, a terminal (terminal device) may be referred to as a mobile station (MS), a user equipment (UE), a user terminal (UT), a wireless terminal, an access terminal, a terminal, a subscriber unit, a subscriber station, a wireless device, a wireless communication device, a wireless transmit/receive unit (WTRU), a mobile node, a mobile, or other terms. Various embodiments of the terminal include a cellular telephone, a smartphone having a wireless communication function, a personal digital assistant (PDA) having a wireless communication function, a wireless modem, a mobile computer having a wireless communication function, a photographing device such as a digital camera having a wireless communication function, a gaming device having a wireless communication function, music storage and playback home appliances having a wireless communication function, and Internet home appliances capable of wireless Internet access and browsing, and may further include portable units or terminals in which combinations of such functions have been integrated. Furthermore, the terminal may include an M2M terminal and an MTC terminal/device, but is not limited thereto. In the disclosure, the terminal may be called an electronic device.

In the present disclosure, the terminal may have an SSP embedded therein, wherein the SSP can download and install a bundle. In addition, an SSP physically separately from the terminal may be inserted into a slot the terminal and connected to the terminal, wherein the slot may have an SSP equipped therein. For example, the SSP may be inserted into the terminal as a card. In this case, a separate SSP may be equipped with the terminal having the SSP embedded therein. The terminal including the SSP may be referred to as an SSP terminal.

In the present disclosure, a local bundle assistant (LBA) means software or an application installed in a terminal which can control the SSP. The LBA may download a bundle in the SSP and transfer a management command such as an activation, a deactivation, and a deletion command of a bundle preinstalled in the SSP. The terminal may include a local profile assistant (LPA) which is software or an application installed in the terminal to control the eUICC. The LPA may be implemented to be included in a sub-component of the local bundle assistant of the local bundle assistant (LBA), and may exist in a terminal as an application separate from the LBA. The LPA may be software or an application which can control an eSIM bundle which is functionally similar to the eUICC, among bundles installed in the SSP in the terminal.

Bundle Management

In the present disclosure, bundle management may be a term including changing a state (activation, deactivation, or deletion) of a bundle installed in the SSP, metadata update of a bundle installed in the SSP, acquisition of a list of bundles installed in the SSP, installing of a bundle in the SSP, and the like.

The bundle management may be divided into local bundle management (LBM) remote bundle management.

The local bundle management (LBM) may mean an operation which is performed as direct use of an SSP terminal and manages an SSP and a bundle installed in the SSP through software in the SSP terminal. The local bundle management (LBM) may be called bundle local management and local management. A terminal software LBA of the SSP terminal may transfer a local bundle management command carrying information on a bundle subject to local bundle management and a specific operation to be performed. The local bundle management command may be called a local management command and a local command. A local bundle management package (LBM package) may be configured to include one or more local bundle management commands transferred from a terminal software LBA to a secondary platform bundle loader (SPBL). The local bundle management package may be called a bundle local management package, a local management package, a local management command package, and a local command package.

A user of the SSP terminal may perform local bundle management through a local bundle assistant installed in the terminal, software which has a right to access the SSP, and the like. An operation which can be performed through local bundle management may include an operation of changing a state (enabled, disable, or deleted) of a target bundle or updating partial information or value of the target bundle, and the like. The operation of updating the partial information or value may be an operation of updating information in the bundle metadata. The target bundle may be used as a term indicating a bundle subject to local bundle management.

Remote bundle management (RBM) may mean an operation which is performed by a command transferred by an external server, that is, a service provider, a remote management server, a bundle management server (secondary platform bundle manager (SPB manager)), and the like, and manages an SSP and a bundle installed in the SSP through software in the SSP terminal. The RBM may be called bundle remote management and remote management.

A service provider or a terminal owner (device owner) may generate a remote bundle management command carrying information on a bundle subject to remote bundle management and a specific operation to be performed. The remote bundle management command may be called a remote management command and a local command. The remote bundle management command may be transferred from a bundle management server (SPB manager) to a terminal software LBA of the SSP terminal in which the remote bundle management command is to be performed. The remote bundle management command may be transferred to a secondary platform bundle loader (SPBL) by the terminal software LBA of the SSP terminal, and bundle management can be performed according to the detail of the command.

The remote bundle management package (RBM package) may be configured to include one or more remote bundle management commands generated by an external server, transferred from the external service to the SSP terminal software LBA, and transferred from the terminal software LBA to the secondary platform bundle loader. The remote bundle management package may be called a bundle remote management package, a remote management package, a remote management command package, and a remote command package.

In the present disclosure, an operation of activating (enabling) a bundle by a terminal or an external server may mean an operation of changing the state of the corresponding profile to the activated (enabled) state and making configuration so that a terminal can receive a service (e.g., a communication service through a communication operator, a credit card payment service, a user authentication service, etc.) provided by the corresponding bundle. The bundle in the activated state may be expressed as an “activated bundle (enabled bundle).” The bundle in the activated state may be stored in the encrypted state in a storage inside or outside the SSP. In the disclosure, the activated state of the bundle (enabled secondary platform bundle or enabled bundle) may be changed to an active state according to an internal operation of the bundle (e.g., timer or polling) or a bundle external input (e.g., a user input, a push, a request from an application in a terminal, a request for authentication from a commutation operator, a PP management message, etc.). The bundle in the active state may mean loading in an active memory in the SSP from a storage inside or outside of the SSP, processing security information by using a secure control device (secure CPU) in the SSP, and providing a security service to the terminal.

In the present disclosure, an operation of deactivating (disabling) a bundle by a terminal or an external server may mean an operation of changing the state of the corresponding bundle to the deactivated (disabled) state and performing configuration so as to refrain the terminal from receiving a service provided by the corresponding bundle. A profile in the deactivated state may be expressed as a “deactivated bundle (disabled secondary platform bundle or disabled bundle.” The bundle in the activated state may be stored in the encrypted state in a storage inside or outside the SSP.

Si2 and Si3 Interface

In the present disclosure, a function invoked by the LBA may be a function performed in an Si2 interface corresponding to an interface between the LBA and the SPB manager and an Si3 interface corresponding to an interface between the LBA and the SPBL. The LBA may transfer a parameter to the SPB manager or the SPBL through a specific function. Parameters transferred from the LBA through invoking of the specific function may be referred to as a function instruction, a function command, or a command. The SPB manager or the SPBL having received the function command may perform a specific operation according to the function command and may respond to the function command. The response may include parameters. The transferring of the function command through the Si2 interface may use a hypertext transfer protocol (HTTP). Specifically, the transferring of the function command through the Si2 may use an HTTP POST request message of the HTTP, and a command may be carried in the body part of the HTTP POST request message and transferred.

Forming (Generating) APDU Pipe

An APDU pipe corresponds to a pipe formed between two hosts for APDU communication. The APDU pipe is formed between a UICC APDU application gate of one host and a UICC APDU service gate of another host. A process of forming the APDU pipe between two host may be performed with reference to ETSI TS 102 622 corresponding to a host controller interface (HCI) standard and ETSI TS103 666-1 or ETSI TS 103 666-2 corresponding to an SSP/iSSP standard.

The APDU pipe may be also called a UICC pipe, a UICC APDU pipe, etc.

The UICC application gate may be called a UICC application gate.

The UICC APDU service gate may be called a UICC service gate.

HCI Configuration

A host controller interface (HCI) defines an interface between hosts. The HCI may follow definition in the standard document of ETSI TS 102 622 (smart card, UICC—contactless front-end (CLF) interface); host controller interface (HCI).

The HCI includes a command, a response, a gate for exchanging an event, a mechanism for transferring a host controller protocol (HCP) message, and an HCP routing mechanism.

The host corresponds to a logical entity in which one or more services are operated. The service may be a set of a series of functions performing a specific function as a set of atomic functions.

The gate may be a commutation entry (entry point) of a service operating in a host.

A gate for management of a host network may be called a management gate.

A network controller host and all hosts in an iSSP may have an administration gate.

A network controller host and all hosts in an iSSP may have a link management gate.

A network controller host and all hosts in an iSSP may have an identity management gate.

A network controller host and all hosts in an iSSP may have a loop back gate.

A network controller host and all hosts in an iSSP may have one or multiple generic gates.

A pipe corresponds to a logical communication channel formed between two gates of different hosts.

Each of the host, the gate, and the pipe may have an identifier, and the host, the gate, and the pipe may be called a host identifier (host ID), a gate identifier (gate ID), and a pipe identifier (pipe ID), respectively.

With regard to the host identifier, a specific host may have a fixed identifier as below:

Host controller identifier: “00,” terminal host identifier: “01,” UICC host identifier: “02.”

Identifier values “80” to “BF” may be flexibly assigned to hosts by a network host controller of an entity for managing a host identifier in the iSSP.

The gate identifier may be used to identify the type of a gate.

The pipe identifier may have a 7 bit length. The pipe identifier may be used as a header of an HCP packet and may be used for packet routing in the iSSP.

A host identifier in a telecom bundle inf the iSSP may have UICC host identifier “02,” but may use another value.

An identifier of each of other hosts in the iSSP may be assigned by a host controller or a network controller host.

Multi-SIM Modem

A multi-SIM modem is a modem supporting multiple logical basebands to support multi-SIM multi-standby or a multi-SIM multi-active terminal. As an example of the multi-SIM multi-standby may include dual-SIM dual-standby (DSDS) supporting a dual-SIM function using two SIM cards. The multi-SIM multi-standby (MSMS) and the multi-SIM multi-active (MSMA) are in common in that a modem supports multiple logical basebands. The MSMS differs from the MSMA in that the MSMA has multiple transceivers to support access via multiple networks which are completely separated from each other, but the MSMS shares one transceiver among multiple logical basebands through time division multiplexing so as to support access via multiple networks. In the disclosure, the multi-SIM modem may correspond to a modem host domain, and the modem host domain may include at least one modem host.

In the present disclosure, one logical baseband may mean a network protocol stack which can perform network (for example, 3GPP network) access based on information (for example, SIM authentication information) on one communication subscriber identifier. Digital information which has gone through a logical baseband may be modulated through a transceiver, a signal thereof may be transmitted as an analog signal, and after the analog signal received through the transceiver is converted and modulated into a digital signal, a decoding processing may be performed through a local baseband. According to the performance of the modem, the logical baseband may support, for example, GSM, 3G, 4G LTE, and 5G, and multiple logical basebands of the multi-SIM modem may support cellular commutation at the same level (e.g., multiple logical basebands support only up to 4G LTE, or all of the multiple logical basebands support 5G), or may support cellular networks at different levels (e.g., among multiple logical basebands, one logical baseband supports 5G, and another logical baseband supports up to 4G LTE).

The multi-SIM modem may be connected to multiple physical SIMS, an eUICC, and a telecom bundle. The multi-SIM modem may have as many SIM ports as the number of SIMS which can be simultaneously supported. Specifically, the SIM port carried by the multi-SIM modem in the iSSP may be called an iSSP SIM port (iSIM port).

The iSIM port may be seen as an independent SIM slot in a higher-layer of an operation system/framework of a terminal. For example, according to the global platform open mobile API standard, the iSIM port may correspond to a card reader class. In addition, the iSIM port may be used as a medium allowing a user in an UI of the terminal to connect a specific bundle to a specific baseband and activate the bundle.

A multi-SIM modem having two independent logical basebands may have two iSIM ports, and likewise, a multi-SIM modem having an independent logical basebands may have n iSIM ports.

The multi-SIM modem having two iSIM ports may simultaneously support two different UICCs, eUICCs, and telecom bundles, and likewise, the multi-SIM modem having n iSIM ports may simultaneously support n different UICCs, eUICCs, and telecom bundles. Here, the supporting means accessing via network by using authentication information in the UICC, the eUICC, the telecom bundle and providing a communication service.

In the present disclosure, when it is determined that a detailed description for the known function or configuration related to the disclosure may obscure the gist of the disclosure, the detailed description thereof will be omitted.

FIG. 1 illustrates an interface between an element and an internal element of an SSP terminal according to various embodiments of the present disclosure.

Referring to FIG. 1, an SSP terminal 101 may include an SSP 131 and a local bundle assistant (LBA) 111 corresponding to terminal software. In addition, the SSP terminal 101 may include a transceiver for transmitting or receiving a signal to or from another terminal, a base station, a server, and the like, and a controller for controlling an overall operation of the SSP terminal 101. The controller may control an operation of the SSP terminal according to various embodiments of the disclosure. The controller may include at least one processor. The controller may control the SSP 131 through the LBA 111.

The SSP 131 may include a primary platform 135, a primary platform interface 134, a secondary platform bundle 133, and a secondary platform bundler loader 132. The primary platform 135 may include a hardware platform and a low-level operating system. The secondary platform bundle 133 may be simply referred to as a bundle, and the bundle includes an application and a high-level operating system (HLOS) driven on the primary platform 135. The secondary platform bundle loader 132 may be simply referred to as an SPB loader or a loader. The loader 132 is a type of the bundle 133, and may correspond to a system bundle having a special right to manage the bundle 133 installed in the SSP. The terminal software LBA 111 and the loader 132 may exchange an instruction and information through a first interface 122. The first interface 122 may be referred to as an Si3 interface.

The LBA 111 may be perform following operations through the first interface:
Acquisition of first SSP information and SSP credential from the loader 132;
Transmission of server credential;
Transmission of bundle data to be installed in the SSP, to the loader 132; and/or
Management of a bundle installed in the SSP (activation, deactivation, deletion, bundle metadata update, management of a list of the installed bundles, etc.).

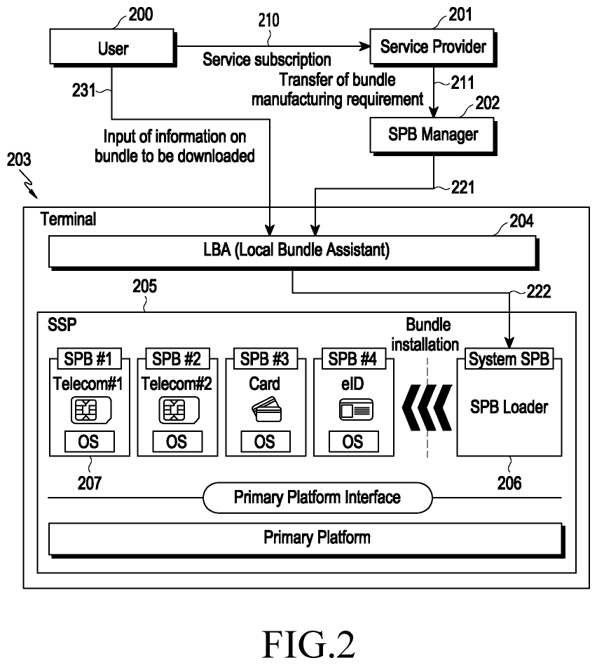

FIG. 2 illustrates a terminal internal or external element for downloading a bundle by an SSP terminal according to various embodiments of the present disclosure.

In the embodiment of FIG. 2, a terminal 203 corresponds to the SSP terminal 101 of FIG. 1. An LBA 204 may correspond to the LBA 111 of FIG. 1. An SPB loader 206 may correspond to the secondary platform bundle loader 132 of FIG. 1. A bundle 207 may corresponds to the secondary platform bundle 133 of FIG. 1. The terminal 203, the LBA 204, and the SPB loader 206 are described with reference to the embodiment of FIG. 1.

According to FIG. 2, a user 200 may select and subscribe a service (e.g., call and data service through a mobile communication network, etc.) provided by a service provider 201 in a service subscription process 210. In the service subscription process 210, the service provider 201 may pay the service provider 201 a predetermined amount or a subscription fee for a service, and the service provider 201 may provide the user 200 with predetermined information for installing the bundle 207 capable of receiving a service in the terminal 203 of the user. In the service subscription process 210, in order to use the service provided by the service provider 201, the user 200 may selectively transfer, to the service provider 201, an SSP identifier of an SSP 205 in the terminal 203 in which the bundler 207 is to be installed. The SSP identifier transferred to the service provider 201 in the service subscription process 210 may allow the bundle 207 purchased by the user 200 to be installed only in the SSP 205 having the corresponding SSP identifier.

According to some embodiments, in the service subscription process 210 in FIG. 2, an SSP activation code may be issued from the service provider 201 to the terminal 200 as predetermined information required to install the bundle 207 in the terminal 203. The SSP activation code may be provided as a QR code format, or may be issued with a link in a uniform resource identifier (URI) format or a string through an email, text, or an application associated with the service provider. According to some embodiments, the SSP activation code provided after the user 200 subscribes to a telecom service may include an eSIM activation code allowing an eSIM profile to be downloaded instead of a telecom bundle, together with information allowing the telecom bundle to be downloaded.

In a bundle manufacturing requirement transferring process 211, the service provider 201 and an SPB manager 202 may perform a bundle download preparation procedure. In the bundle manufacturing requirement transferring process 211, the service provider 201 may selectively transfer, to the SPB manager 202, an identifier (an SSP ID) of the SSP 205 in which the bundle is to be installed, and may transfer, to the SPB manager 202, at least one of a bundle family identifier (SPB family ID) and a specific bundle identifier (SPB ID) capable of providing a service selected by a subscriber. In the bundle manufacturing requirement transferring process 211, the SPB manager 202 may select one of a bundle having the transferred specific bundle identifier and a bundle having the bundle family identifier, and may transfer the selected bundle identifier to the service provider 201.

In the bundle manufacturing requirement transferring process 211, the service provider 201 or the SPB manager 202 may newly generate a bundle matching ID which can distinguish the selected bundle. The bundle matching ID which can distinguish the bundle may be referred to as CODE_M. In addition, the SPB manager 202 may connect the transferred SSP identifier (SSP ID) to the selected bundle to manage the same. In the bundle manufacturing requirement transferring process 211, the SPB manager 202 may transfer a bundle manage server address (SPB manager address) from which the selected bundle can be downloaded, to the service provider 201.

In this case, the bundle management server address may be an address of a specific or a predetermined bundle management server in which a prepared bundle is stored, and may be an address of another bundle management server in which download information (for example, a server address, etc.) of the prepared bundle is installed and acquired. In the bundle manufacturing requirement transferring process 211, when the service provider 201 requests preparation for the telecom bundle from the SPB manager 202, information on the eSIM profile matching to the corresponding telecom bundle may be provided together.

When a part of the bundle manufacturing requirement transferring process 211 precedes the service subscription process 210, the service provider 201 may transfer, in the service subscription process 210, bundle download information prepared for the user 200. As the bundle download information, at least one of the bundle management server address (SPB manager address) in which the bundle is prepared, the bundle matching ID of the prepared bundle, or the bundle family identifier of the prepared bundle may be selectively transferred.

Referring to FIG. 2, in a process 231of inputting information of a bundle to be downloaded, bundle download information may be transferred to the LBA 204 of the terminal 203. The bundle downlink information may be at least one of an address (SPB manager address) of a bundle management server to which the LBA 204 is to access, a bundle identifier of a bundle prepared in the bundle manufacturing requirement transferring process 211, or a bundle family identifier of the prepared bundle. The bundle identifier may include at least one of a bundle event ID or a bundle matching ID generated in the bundle manufacturing requirement transferring process 211. In addition, the bundle identifier may include a bundle family identifier of the prepared bundle. The bundle event ID may include at least one of the bundle management server address and the bundle matching ID of the bundle prepared in the bundle manufacturing requirement transferring process 211. The bundle download information may be input when the user 200 inputs an SSP activation code (e.g., scan a QR code, directly input text, etc.) to the LBA 204, or may be input to the LBA 204 by means of a push input through an information provision server (not shown). In addition, the LBA 204 access the information provision server (not shown) preconfigured in the terminal 203 and receive the bundle download information.

The bundle download to the SSP 205 in the SPB manager 202 may be implemented as an operation and a function configured in an interface 221 between the SPB manger 202 and the LBA 204 and an interface 222 between the LBA 204 and the SPB loader 206. The interface 222 between the LBA 204 and the SPB loader 206 may correspond to the first interface 122 of FIG. 1. The interface 222 between the LBA 204 and the SPB loader 206 may be referred to as an Si3 interface.

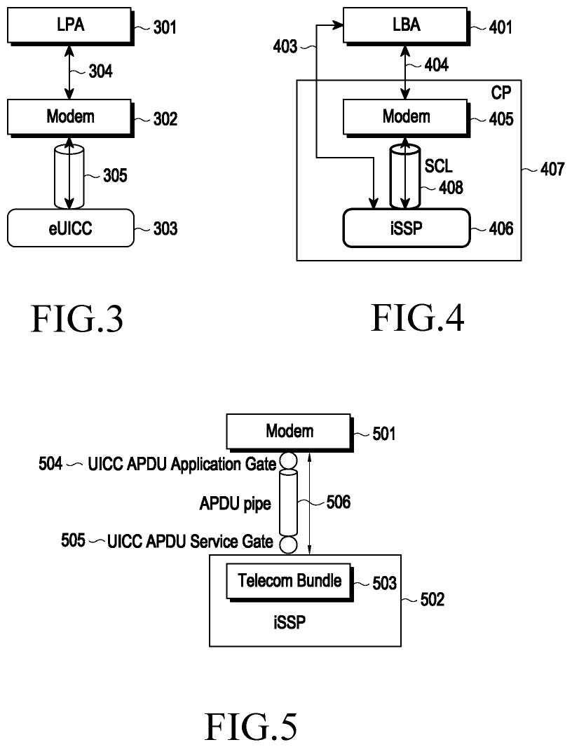

FIG. 3 illustrates elements of an eUICC terminal according to various embodiments of the present disclosure.

An LPA 301 may transmit an APDU command to an eUICC 303 and receive an APDU response therefrom. The APDU command and response correspond to data fowling ETSI TS 102 221 and SGP. 22 standard based on ISO 7816-4. The APDU command and response may be used for communication between the LPA 301 and the eUICC 303 and communication between a modem 302 and the eUICC 303.

The LPA 301 and the eUICC 303 may go through the modem 302 for APDU transmission or reception. The LPA 301 may transfer an APDU to be transmitted to the eUICC 303 to the modem through a first interface 304 provided by the modem 302. The first interface 304 may correspond to an interface for transferring an APDU to the modem through a framework of a terminal or an operating system of the terminal. The first interface may correspond to an interface for containing an APDU to be transmitted by the LPA 301 in an AT command and transmitting the same to the modem 302. The modem 302 may exchange the APDU with the eUICC 303 through a second interface 305. The second interface may correspond to an interface based on ISO 7816-3.

FIG. 4 illustrates elements of an iSSP terminal according to various embodiments of the present disclosure.

An iSSP terminal may include a modem 405 and an iSSP 406 embedded in a communication processor (CP) 407.

The iSSP 406 may be collectively called a secondary platform bundler loader (SPBL) in the iSSP and secondary bundles installed in the iSSP.

Communication between an LBA 401 and the SPBL in the iSSP 406 may be performed through a third interface 403. The third interface 403 may be called an Si3 interface. A command and a response transferred through the third interface 403 may be called an Si3 command and an Si3 response, respectively.

The LBA 401 may transfer the Si3 command to the SPBL in the iSSP 406 and may receive a response therefrom.

The LBA 401 may transmit or receive data to or from the modem 405 through a fourth interface 404.

The modem 405 and the iSSP 406 may transmit or receive data through a fifth interface 408. The fifth interface 408 may correspond to an interface following an SSP common layer (SCL) defined in ETSI TS 103 666-1. An SCL transport layer may correspond to a ETSI TS 102 622 host controller interface (HCI). The fifth interface 408 may correspond to an APDU pipe formed between a UICC APDU application gate of the modem 405 and a UICC APDU service gate of a specific bundle in the iSSP 406.

FIG. 5 illustrates examples of an interface for APDU communication between a modem and a telecom bundle according to various embodiments of the present disclosure.

An APDU pipe 506 formed between a modem 501 and a telecom bundle 503 in FIG. 5 may be an example of the fifth interface 408 of FIG. 4.

The modem 501 may perform APDU communication by forming the APDU pipe 506 with the telecom bundle 503 installed in the iSSP 502. The APDU pipe 506 may be generated while having a UICC APDU application gate 504 and a UICC APDU service gate 505 of the modem 501 as entries (entry points).

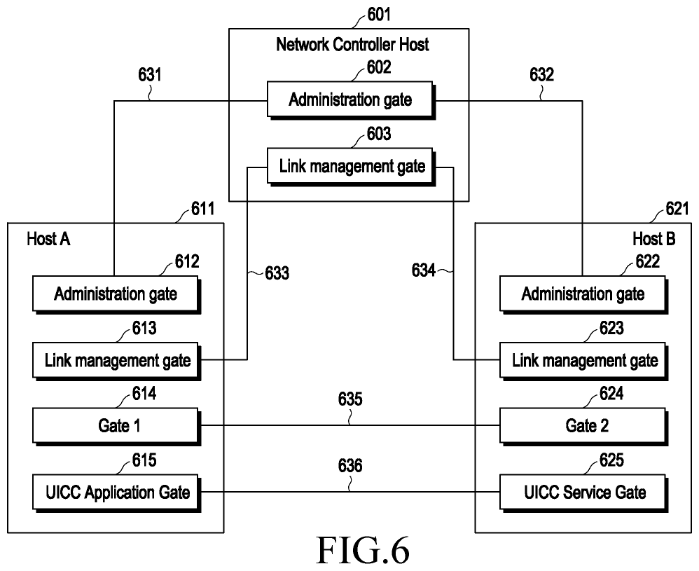

FIG. 6 illustrates an example in which hosts in an iSSP generate a pipe through a gate according to various embodiment of the present disclosure.

A network controller host 601 of the iSSP may include an administration gate 602. The administration gate 602 may form pipes with administration gates 612 and 622 in host A 611 and host B 621 that are different hosts, respectively (631 and 632), so as to perform an administration function between the hosts.

A link management gate 603 of the network controller host 601 may form pipes with link management gates 613 and 623 in host A 611 and host B 621 that are different hosts, respectively (633 and 634), so as to perform a function (link management) of managing connection of a link between hosts.

Host A 611 and host B 621 may form pipes through gates corresponding to a specific service, and may perform a service by exchanging a command and a response or exchanging an event.

Gate 1 614 in host A 611 and gate 2 in host B 621, which correspond to the same service, may form a pipe 635 therebetween to perform the corresponding service.

If host A 611 corresponds to a modem and host B 621 corresponds to a telecom bundle, an APDU pipe 636 may be formed between a UICC application gate 615 in host A 611 and a UICC service gate 625 in host B 621 to perform APDU communication and perform various services and functions performed in the UICC.

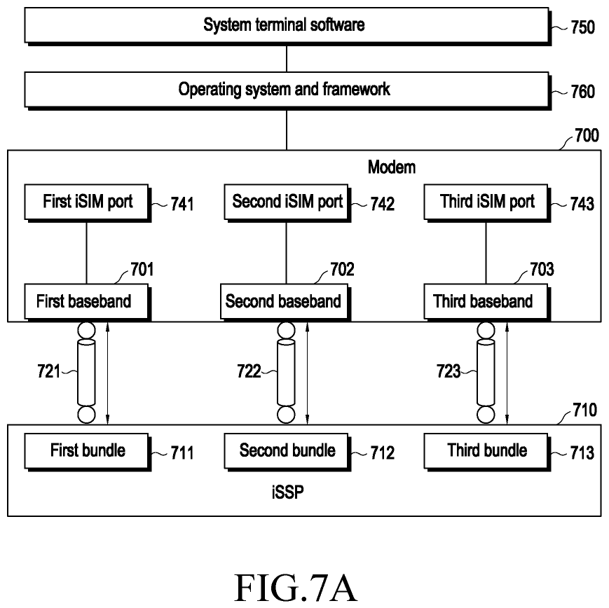

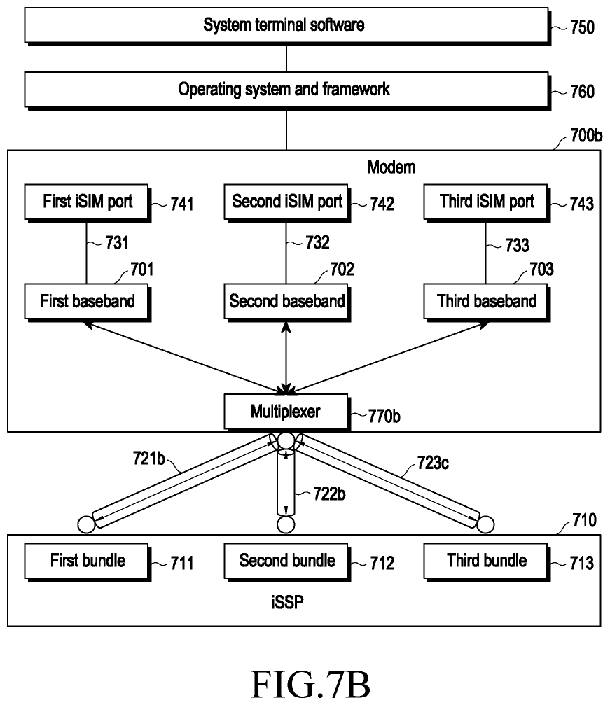

FIG. 7A illustrates a multi-SIM modem of a terminal and a state in which multiple telecom bundles in an iSSP are connected to iSIM ports, respectively, according to various embodiments of the present disclosure.

A multi-SIM modem 700 supports multiple logical basebands 701, 702, and 703. The multi-SIM modem 700 in FIG. 7A may be an example of a triple-SIM modem supporting three logical basebands and three iSIM ports.

The first logical baseband 701, the second logical baseband 702, and the third logical baseband 703 may support the same radio access capability or different radio access capabilities. For example, all of three logical basebands may be logical basebands supporting a 5G network. In another example, two of three logical basebands may support a 5G network, and the other one logical baseband may support a 4G network. In another example, three logical basebands may support 4G, 5G, and 6G networks, respectively.

A modem 700 of FIG. 7A has three iSIM ports. Three iSIM ports corresponds to a first iSIM port 741, a second iSIM port 742, and a third iSIM port 743.

In FIG. 7A, the first iSIM port 741 corresponds to an iSIM port using the first baseband 701, the second iSIM port 742 corresponds to an iSIM port using the second baseband 702, and the third iSIM port 743 corresponds to an iSIM port using the third baseband 703.

FIG. 7A shows that a first bundle 711 accesses a network by using the first baseband 701, a second bundle 712 accesses a network by using the second baseband 702, and a third bundle 713 accesses a network by using the third baseband 703.

FIG. 7A shows that the first bundle 711 is connected to the first iSIM port 741, the second bundle 712 is connected to the second iSIM port 742, and the third bundle 713 is connected to the third iSIM port 743.

According to FIG. 7A, the first iSIM port 741 is connected to the first baseband 701, and the first bundle 711 is activated and forms a first pipe 721 with a gate connected to the first baseband 701, so as to be connected to the first iSIM port 741.

Similarly, according to FIG. 7A, the second iSIM port 742 is connected to the second baseband 702, and the second bundle 712 is activated and forms a second pipe 722 with a gate connected to the second baseband 702, so as to be connected to the second iSIM port 742.

Similarly, according to FIG. 7A, the third iSIM port 743 is connected to the third baseband 703, and the third bundle 713 is activated and forms a third pipe 723 with a gate connected to the third baseband 703, so as to be connected to the third iSIM port 743.

Although not shown, connection relationships 731, 732, and 733 between the iSIM ports 741, 742, and 743 and the logical basebands 701, 702, and 703 may change according to a modem configuration. The modem configuration may change by system terminal software 750. The system terminal software 750 may correspond to system software which can manage the modem 700 by using an API provided through an operating system and framework 760 by the modem 700. For example, the system terminal software 750 may correspond to terminal software having a system access right, such as a SIM card manager of an Android terminal. Upon the user's selection, the system terminal software 750 may change connection relationships 731, 732, and 733 between the iSIM ports 741, 742, and 743 and the basebands 701, 702, and 703. For example, according to a specific configuration, the first iSIM port 741 may be connected to the second baseband 702, and the second iSIM port 742 may be connected to the third baseband 703, and the third iSIM port 743 may be connected to the first baseband 701. In addition, the iSIM ports and the logical basebands may be connected to each other according to any combinations satisfying 1:1 correspondence (bijection) therebetween.

FIG. 7B illustrates another embodiment of a multi-SIM modem of a terminal and a state in which multiple telecom bundles in an iSSP are connected to iSIM ports, respectively, according to various embodiments of the disclosure.

Compared to the embodiment of FIG. 7A, the embodiment of FIG. 7B is different from the embodiment of FIG. 7A in that a modem 700b includes a multiplexer 770b and has only one UICC application gate. In this case, gates (UICC service gates) of multiple bundles 711, 712, and 713 may be connected (mapped) to one gate (UICC application gate) of the modem 700b.

As shown in FIG. 7B, in the modem 700b, the first bundle 711, the second bundle 712, and the third bundle 713 may be activated and form a first UICC pipe 721b, a second UICC pipe 722b, and a third UICC pipe 723c, respectively. Specifically, the first bundle 711, the second bundle 712, and the third bundle 713 may be activated, and the first UICC pipe 721b, the second UICC pipe 722b, and the third UICC pipe 723c may be formed between a gate (one UICC application gate) of the modem 700b and a gate of the first bundle 711, a gate of the second bundle 712, and a gate of the third bundle 713 (three UICC service gates), respectively. In this case, the multiplexer 770b may multiplex communication with the first bundle 711, the second bundle 712, and the third bundle 713 through a pipe ID of three UICC pipes 721b, 722b, and 723bgenerated by one UICC application gate.

According to an embodiment, operations described in the embodiment of FIG. 7B may be applied to not only a case in which a modem includes only one UICC application gate as shown in FIG. 7B, but also a case in which UICC service gates of multiple bundles are connected (mapped) to one UICC application gate. For example, the description in the embodiment of FIG. 7B may be also applied to a case in which a modem includes two UICC application gates, and one of two UICC application gates is connected (mapped) to UICC service gates of multiple bundles.

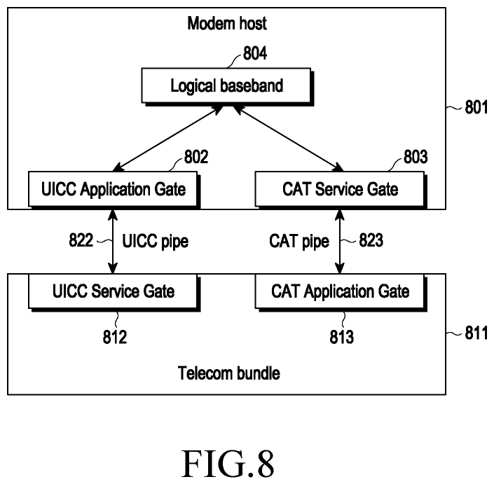

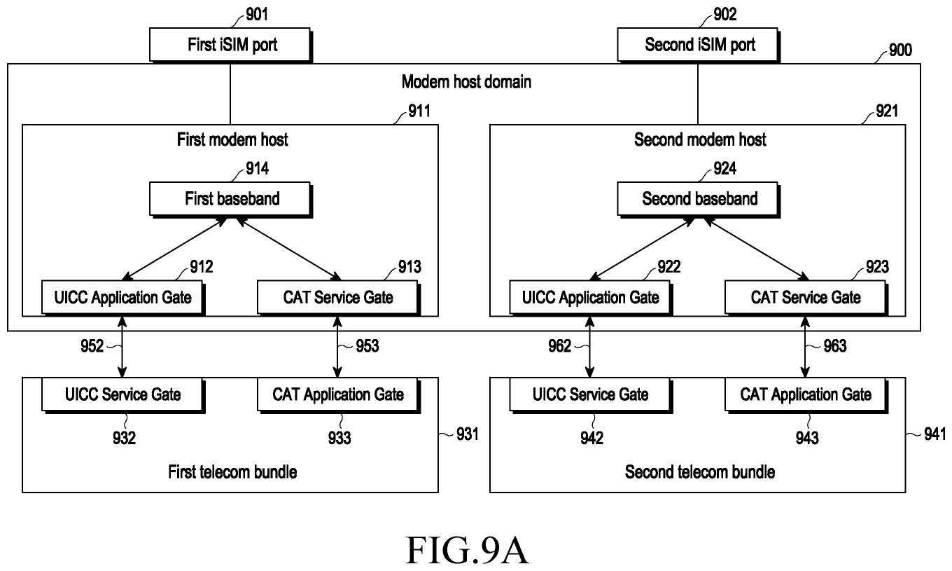

FIG. 8 illustrates an example of forming a pipe for communication between a modem host and a telecom bundle according to various embodiments of the present disclosure.

A modem host 801 may include one logical baseband 804. The logical baseband 804 may mean, for example, a protocol stack for network access using SIM authentication information.

The modem host 801 may include a UICC application gate 822. The UICC application gate 822 may form a UICC pipe 822 with a UICC service gate 812 of a telecom bundle 811 to perform a UICC function.

The modem host 801 may include a card application toolkit (CAT) service gate 803. The CAT service gate 803 may form a CAT pipe 823 with a CAT application gate 813 of the telecom bundle 811 to perform a CAT service. The card application toolkit may refer to the standard of ETSI TS 102 223 smart cards; card application toolkit (CAT). For example, the CAT application gate 813 of telecom bundle 811 may transmit a proactive UICC command to a modem by transferring the protective UICC command to the CAT service gate 803 through the CAT pipe 823.

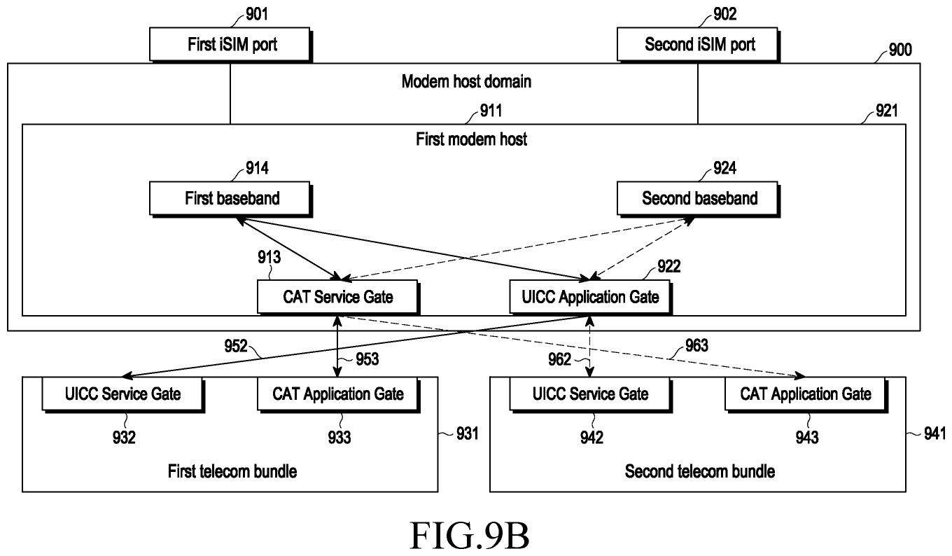

FIG. 9A illustrates an example in which multiple telecom bundles are activated in a multi-SIM modem and connected to iSIM ports according to various embodiments of the present disclosure.

In the disclosure, the multi-SIM modem may be called a modem host domain 900. The modem host domain 900 may be a host domain outside the SSP host domain. The modem host domain 900 may have multiple modem hosts. FIG. 9A illustrates an example of a dual-SIM modem, wherein the modem host domain 900 of the dual-SIM modem may include two modem hosts (for example, a first modem host 911 and a second modem host 912).

In the disclosure, the SSP host domain may include at least one host. For example, as illustrated in FIG. 9A, the SSP host domain may include a first host corresponding to the first telecom bundle 931 and a second host corresponding to the second telecom bundle 941. In the embodiment of FIG. 9A, a host (e.g., first modem host 911) in modem host domain 900 may generate the APDU pipe (UICC) pipe with a host (e.g., first telecom bundle 931) in SSP host domain.

In the embodiment, the first modem host 911 and the second modem host 921 may correspond to the modem host 801 of FIG. 8.

FIG. 9A shows an example in which the first modem host 911 is connected to a first iSIM port 901 and the second modem host 921 is connected to a second iSIM port 902.

According to FIG. 9A, a first telecom bundle 931 is activated and forms a UICC pipe 952 and a CAT pipe 953 with the first modem host 911, and may perform network access through a first baseband 914.

According to FIG. 9A, the first modem host 911 is connected to the first iSIM port 901, and thus it may be understood that the first telecom bundle 931 is connected to the first iSIM port 901.

In addition, according to FIG. 9A, the second telecom bundle 941 is activated and forms a UICC pipe 962 and a CAT pipe 963 with the second modem host 921, and may perform network access through a second baseband 954.

According to FIG. 9A, the second modem host 921 is connected to the second iSIM port 902, and thus it may be understood that the second telecom bundle 941 is connected to the second iSIM port 902.

FIG. 9B illustrates another example in which multiple telecom bundles are activated in a multi-SIM modem and connected to iSIM ports according to various embodiments of the present disclosure.

There is a different between FIG. 9A and FIG. 9B in that the modem host domain 900 of FIG. 9B has a single modem host (for example, a first modem host 911). The first modem host 911 has multiple basebands 914 and 924 and may also has a UICC application gate 922 and a CAT service gate 913 used for communication with telecom bundles.

In the embodiment of FIG. 9B, a host (e.g., first modem host 911) in modem host domain 900 may generate the APDU pipe (UICC) pipe with a plurality of hosts (e.g., first telecom bundle 931 and first telecom bundle 941) in SSP host domain.

According to FIG. 9B, when a first telecom bundle 931 and a second telecom bundle 941 are activated and form pipes with the first modem host 911, both a UICC service gate 932 of the first telecom bundle 931 and a UICC service gate 942 of the second telecom bundle 941 may form pipes 952 and 962 with a UICC application gate 922 of the first modem host 911. In this case, the first modem host 911 may classify a bundle to be used for communication, through an identifier of a pipe.

Although not shown, a multiplexer of the first modem host 911 may classify a bundle with which the UICC application gate 922 forms a pipe (for example, either 952 or 962), through an identifier of the pipe.

In addition, when the first telecom bundle 931 and the second telecom bundle 941 are activated and form pipes with the first modem host 911, both the CAT application gate 933 of the first telecom bundle 931 and the CAT application service gate 943 of the second telecom bundle 941 may form pipes with the CAT service gate 913 of the first modem host 911. In this case, the CAT service gate 913 may perform a process by classifying bundles used for communication according to whether a pipe identifier of a transferred packet corresponds to 953 or 963.

If the first telecom bundle 931 is connected to the first iSIM port 901 and uses the first baseband 914, a multiplexer of the first modem host 911 may forward a packet received through the pipe 953 from the CAT service gate to the first baseband 914. Similarly, the UICC application gate may transfer a packet, which is transferred to the first telecom 931 by a terminal through the first iSIM port 901, to the pipe 952 so as to transfer the packet to the UICC service gate 932 of the first telecom bundle 931.

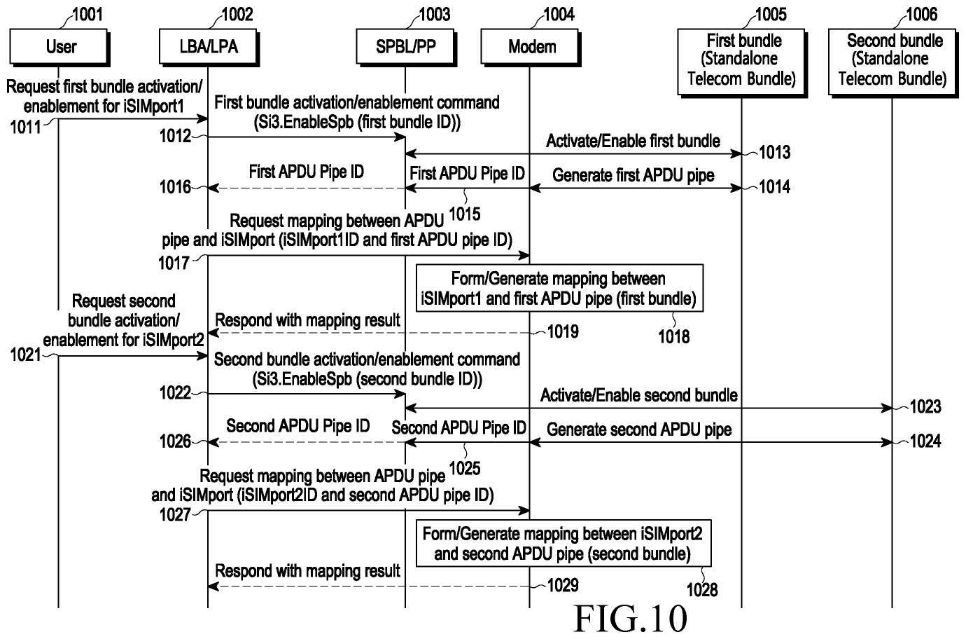

FIG. 10 illustrates an embodiment of a process of activating two telecom bundles upon a user request and allocating two telecom bundles to two SIM ports of a modem, respectively, according to various embodiments of the disclosure.

Operations 1011 to 1019 show a series of embodiments of activating a first bundle 1005 upon a user request and connecting the first bundle 1005 to iSIM port 1 (first SIM port)of the modem.

Operations 1021 to 1029 show a series of embodiments of activating a second bundle 1006 upon a user request and connecting the second bundle 1006 to iSIM port 2 (second SIM port)of the modem.

In operation 1011, a user 1001 requests first bundle activation/enablement to an LBA 1002 (or LPA). In operation 1011, through a SIM card configuration UI of a terminal, a user activates/enables a telecom company of the first bundle in a specific SIM slot. For example, the user may perform first bundle activation in iSIMport1.

In operation 1012, the LBA 1002 transfers a first bundle activation/enablement command to an SPBL 1003. In operation 1012, for example, the first bundle activation command may correspond to a Si3.EnableSpb command including a first bundle identifier.

In operation 1013, the SPBL 1003 activates/enables the first bundle 1005 through a primary platform (PP) of an iSSP. Activating the first bundle may include, for example, decrypting and activating the encrypted first bundle 1005 and moving up the decrypted/activated first bundle 1005 to the next RAM. After the first bundle 1005 is activated, the first bundle 1005 may broadcast to other entities in the iSSP that the first bundle 1005 is activated. For example, the corresponding broadcasting may be performed through an entity called a network controller host in the iSSP.

When the first bundle 1005 is activated, a modem 1004 and the first bundle 1005 form/generate a first APDU pipe in operation 1014.

In operation 1015, the modem 1004 transfers an identifier of the first APDU pipe to the SPBL 1003. Operation 1015 may be performed in connection with a network controller host (NCH) router corresponding to an entity in the iSSP.

In operation 1016, the SPBL 1003 may transfer a response to the first bundle activation command in operation 1012 to the LBA 1002. When the first bundle is successfully activated and forms/generates the first APDU pipe with the modem, the response in operation 1016 may include a first APDU pipe identifier. The LBA 1002 may identify the identifier of the first APDU pipe formed for the first bundle activated in operation 1012 to communicate with the modem, through the first APDU pipe identifier received from the SPBL 1003.

In operation 1017, the LBA 1002 sends an APDU pipe-to-iSIM port mapping request to the modem 1004 to map/connect the first bundle to the iSIM port 1 in the modem. The corresponding APDU pipe-to-iSIM port mapping request may include an identifier of an APDU pipe and an identifier of an iSIM port to be mapped. When there is no direct data transfer route between the LBA 1002 and the modem 1004, operation 1017 may be performed via the SPBL 1003. In this case, the LBA 1002 may transfer the APDU pipe-to-iSIM port mapping request to the SPBL 1003, the SPBL 1003 transfers the mapping request to the modem 1004, and thus the identifier of an APDU pipe and the identifier of an iSIM port to be mapped may be transferred to the modem 1004.

In operation 1018, the modem 1004 may map the iSIMport identifier and the APDU pipe identifier transferred in operation 1017. Operation 1018 may correspond to an operation of connecting a bundle (first bundle) connected via an APDU pipe (first APDU pipe) having the transferred APDU pipe identifier, among APDU pipes formed by the modem with a logical baseband associated with the transferred iSIMport identifier. For example, operation 1018 may correspond to an internal operation of the modem, which allows network access through a logical baseband associated with the iSIMport identifier by utilizing a K value and the IMSI of the first bundle. Through operation 1018, the activated telecom bundles may be connected to a specific logical baseband in the modem to perform network access.

In operation 1019, the modem 1004 respond with the result of the execution of operation 1018. Through operation 1019, the LBA 1002 may recognize that the first bundle is successfully mapped to iSIMport corresponding to iSIMportlID.

Operations 1021 to 1029 show a procedure of activating the second bundle 1006 and mapping the same to iSIMport2. Operations 1021, 1022, 1023, 1024, 1025, 1026, 1027, 1028, and 1029 may be performed with reference to operations 1011, 1012, 1013, 1014, 1015, 1016, 1017, 1018, and 1019, respectively.

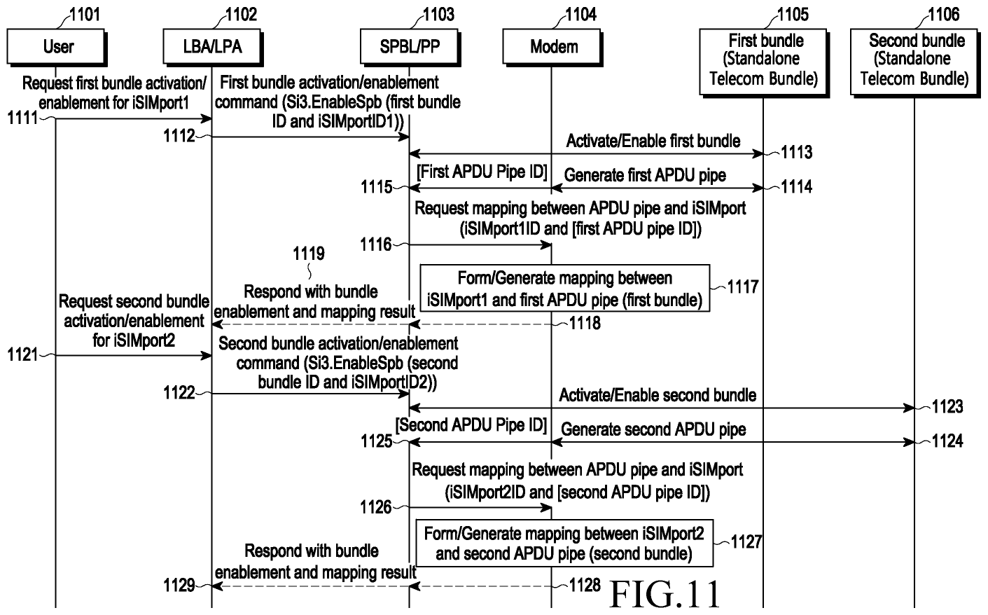

FIG. 11 illustrates another embodiment of a process of activating two telecom bundles upon a user request and allocating two telecom bundles to two SIM ports of a modem, respectively, according to various embodiments of the disclosure.

Unlike FIG. 10, FIG. 11 illustrates some embodiments in which a bundle activation command transmitted to an SPBL 1103 by an LBA 1102 includes an identifier of an iSIM port.

Operations 1111 to 1119 show a series of embodiments of activating a first bundle 1105 upon a user request and connecting the first bundle 1105 to iSIM port 1 (first SIM port) of the modem.

Operations 1121 to 1129 show a series of embodiments of activating a second bundle 1106 upon a user request and connecting the second bundle 1106 to iSIM port 2 (second SIM port)of the modem.

In operation 1111, a user 1101 requests first bundle activation/enablement to an LBA 1102. In operation 1111, through a SIM card configuration UI of a terminal, a user activates/enables a telecom company of the first bundle in a specific SIM slot. For example, the user may perform first bundle activation in iSIMport 1.

In operation 1112, the LBA 1102 transfers a first bundle activation/enablement command to the SPBL 1103. In operation 1112, for example, the first bundle activation command may correspond to a Si3.EnableSpb command including a first bundle identifier and an iSIMport1 identifier.

In operation 1113, the first bundle 1105 is activated through the SPBL 1103. Operation 1113 of FIG. 11 may correspond to operation 1013 of FIG. 10.

In operation 1114, a modem 1104 and the first bundle 1105 forms/generates an APDU pipe. The formed APDU pipe may be called a first APDU pipe. Operation 1114 of FIG. 11 may correspond to operation 1014 of FIG. 10.

In operation 1115, the modem 1104 transfers an identifier of the first APDU pipe to the SPBL 1103. Operation 1115 may be omitted according to some embodiments.

In operation 1116, the SPBL 1103 may request APDU pipe-to-iSIMport mapping/connecting from the modem 1104. The mapping request may include an identifier of the iSIMport. The mapping request may further include an APDU pipe identifier. The APDU pipe identifier included in the mapping request may be the APDU pipe identifier transferred in operation 1115.

In operation 1117, the modem 1104 may perform the iSIM port-to-APDU pipe mapping. According to an example in FIG. 11, operation 1117 may correspond to an operation of mapping the first APDU pipe formed between the modem and the activated first bundle in operation 1113 to the iSIM port corresponding to the iSIMport identifier transferred in operation 1116. Through operation 1117, the first bundle may perform network access by using a logical baseband corresponding to iSIMport1 of the modem upon the user request in operation 1111.

In operation 1118, the modem 1104 may inform the SPBL 1103 of the result showing that operation 1117 is successfully performed.

In operation 1119, the SPBL 1103 may transfer, to the LBA 1102, a result for bundle activation (whether operation is successfully performed) and whether mapping to the iSIM port in the modem of the activated bundle is performed (whether operation 1117 is successfully performed).

In operation 1119, the LBA 1102 responded with successfully bundle activation and successful mapping to the iSIM port may show the user 1101 that the first bundle is activated in iSIMportl and is being used, on a screen through a UI.

Operations 1121 to 1129 show a procedure of activating the second bundle 1106 and mapping the same to iSIMport2. Operations 1121, 1122, 1123, 1124, 1125, 1126, 1127, 1128, and 1129 may be performed with reference to operations 1111, 1112, 1113, 1114, 1115, 1116, 1117, 1118, and 1119, respectively.

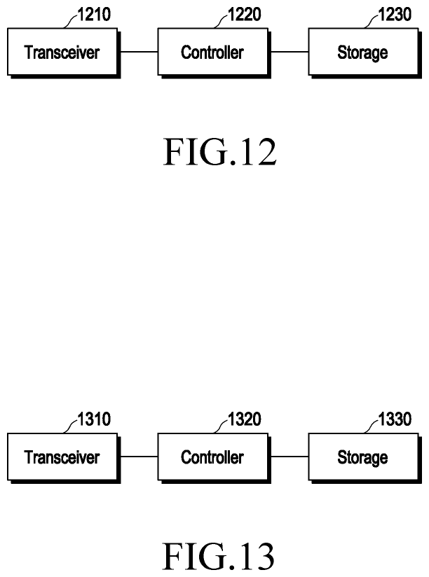

FIG. 12 illustrates a structure of a terminal according to various embodiments of the present disclosure.

Referring to FIG. 12, the terminal may include a transceiver 1210, a controller 1220, and a storage 1230. In the disclosure, the controller 1220 may be defined a circuit, an application-specific integrated circuit, or at least one processor.

The transceiver 1210 may transmit or receive a signal to or from another network entity including a server. For example, the transceiver may receive system information from the server, and may transmit or receive information and/or a message according to the embodiment.

The controller 1220 may control the overall operation of the terminal according to an embodiment provided in the disclosure. For example, the controller may control a signal flow between blocks to perform operations according to the above-described drawings and flow charts.

The storage 1230 may store at least one of information transmitted or received through the transceiver and information generated through the controller.

FIG. 13 illustrates a structure of a smart secure platform according to various embodiments of the present disclosure.

Referring to FIG. 13, the smart secure platform may include a transceiver 1310, a controller 1320, and a storage 1330. In the disclosure, the controller 1320 may be defined a circuit, an application-specific integrated circuit, or at least one processor.

The transceiver 1310 may transmit or receive a signal to or from another network entity within a terminal and/or outside the terminal. For example, the transceiver may receive system information from the controller of the terminal, and may transmit or receive information and/or a message according to the embodiment.

The controller 1320 may control the overall operation of the smart secure platform according to an embodiment provided in the disclosure. For example, the controller may control a signal flow between blocks to perform operations according to the above-described drawings and flow charts.

The storage 1330 may store at least one of information transmitted or received through the transceiver and information generated through the controller.

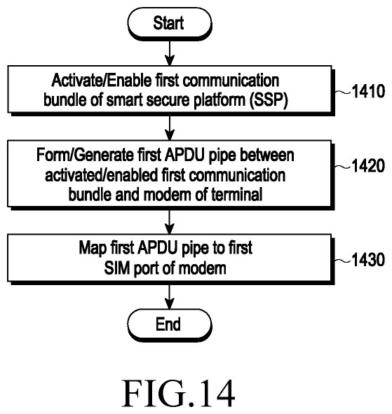

FIG. 14 illustrates a flowchart of a method for a smart secure platform or a terminal according to various embodiments of the present disclosure.

In an embodiment of FIG. 14, a terminal may be, for example, the above-described SSP terminal, and a smart secure platform may be, for example, an iSSP including multiple telecom bundles and an SPBL.

In the embodiment of FIG. 14, the operation of the terminal or the secure platform may be an operation of a controller that controls the corresponding operation.

Referring to FIG. 14, a terminal (or a smart secure platform) may activate/enable a first telecom bundle of a smart secure platform (operation 1410). In an embodiment, the terminal (or the secure platform) may enable a first telecom bundle (communication bundle) of a plurality of telecom bundles of the smart secure platform.

The bundle activation procedure may refer to FIGS. 10 and 11. For example, activating the first telecom bundle may include transmitting a bundle activation/enablement command including an identifier of the first telecom bundle to the smart secure platform. The bundle activation command may be transmitted from an LBA of the terminal to the SPBL of the smart secure platform. In this case, the smart secure platform may activate the first telecom bundle according to the bundle activation command for the first telecom bundle. According to an embodiment, the bundle activation command may further include an identifier of a first SIM port.

The terminal (or the smart secure platform) may form/generate a first APDU pipe between the activated first telecom bundle and a modem of the terminal (operation 1420). In an embodiment of FIG. 14 , the modem may be a modem host domain or a modem host within the modem host domain. In an embodiment, the terminal (or smart secure platform) may generate a first pipe for communication between the enabled first telecom bundle and the modem of the terminal.

The APDU pipe forming procedure may refer to FIGS. 3 to 11. For example, the first APDU pipe may be formed between a gate of the modem and a gate of the activated first telecom bundle according to a predetermined scheme. As shown in FIG. 7B, the modem may include a multiplexer connected to the gate of the modem, and in this case, a second APDU pipe may be further formed between the gate of the modem and a gate of a second telecom bundle of the smart secure platform, the second telecom bundle being different from the first telecom bundle.

The terminal (or the smart secure platform) may map the formed first APDU pipe to a first SIM port (operation 1430). In an embodiment, the terminal (or the smart secure platform) may use the identifier of the SIM port to map the generated first pipe to a first SIM port of a plurality of SIM ports of the modem. Accordingly, the first telecom bundle may be connected to a first logical baseband associated with the first SIM port. The mapping procedure may refer to FIGS. 10 and 11. For example, the mapping may include transmitting a mapping request for mapping the formed first APDU pipe to the first SIM port of the modem, to the modem, and the mapping request may include the identifier of the first SIM port. The mapping request may be transmitted from the LBA of the terminal to the modem, or may be transmitted from the SPBL of the smart secure platform to the modem. According to an embodiment, the mapping request may further include an identifier of the first APDU pipe.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first,” “a second,” “the first,” and “the second” may be used to simply distinguish a corresponding element from another, and does not limit the elements in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled/connected with/to the other element directly (e.g., wiredly), wirelessly, or via another element (e.g., a third element).

As used herein, the term “module” may include a unit implemented in hardware, software, or firmware, and may be interchangeably used with other terms, for example, “logic,” “logic block,” “component,” or “circuit.” The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., program) including instructions that are stored in a storage medium (e.g., internal memory or external memory) that is readable by a machine (e.g., computer). The machine is a device that can invoke the stored instructions from the storage medium and operate according to the invoked instructions, and may include a terminal according to various embodiments. When the instructions are executed by a processor, the processor may perform functions corresponding to the instructions, with or without using one or more other components under the control of the processor. The instructions may include a code generated or executed by a complier or an interpreter.

The machine-readable storage medium may be provided in the form of a non-transitory storage medium. Wherein, the term “non-transitory” simply means that the storage medium is a tangible device, and does not include a signal, but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server. According to various embodiments, each element (e.g., a module or a program) of the above-described elements may include a single entity or multiple entities, and some of the above-described relevant sub elements may be omitted, or other sub elements may be further included in various embodiments. Alternatively or additionally, some elements (e.g., modules or programs) may be integrated into a single element. In such a case, the integrated element may perform functions, which are performed by the respective relevant elements before the integration, in the same or similar manner. According to various embodiments, operations performed by the module, the program, or another element may be carried out sequentially, in parallel, repeatedly, or heuristically, or one or more of the operations may be executed in a different order or omitted, or one or more other operations may be added.

The embodiments of the disclosure described and shown in the specification and the drawings are merely specific examples that have been presented to easily explain the technical contents of the disclosure and help understanding of the disclosure, and are not intended to limit the scope of the disclosure. Therefore, the scope of the disclosure should be construed to include, in addition to the embodiments disclosed herein, all changes and modifications derived on the basis of the disclosure.

In addition, some of all of a specific embodiment of the above-described various embodiments may be performed in connection with some or all of one or more other embodiments.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a terminal comprising a smart secure platform, the method comprising:
enabling a first telecom bundle of a plurality of telecom bundles of the smart secure platform;
generating a first pipe for a communication between the enabled first telecom bundle and a modem of the terminal; and
mapping the generated first pipe to a first subscriber identity module (SIM) port of a plurality of SIM ports of the modem based on an identifier of the first SIM port,
wherein the first SIM port is associated with a first baseband.

2. The method of claim 1, further comprising transmitting, by a local bundle assistant (LBA) of the terminal, a bundle enablement command comprising an identifier of the enabled first telecom bundle to a secondary platform bundle load (SPBL) of the smart secure platform.

3. The method of claim 2, further comprising transmitting, by the LBA, a mapping request for mapping the generated first pipe to the first SIM port of the modem,
wherein the mapping request comprises the identifier of the first SIM port and an identifier of the first pipe.

4. The method of claim 2, further comprising transmitting, by the SPBL, a mapping request for mapping the generated first pipe to the first SIM port to the modem, wherein the bundle enablement command further comprises the identifier of the first SIM port.

5. The method of claim 1, further comprising generating, based on a predetermined configuration, the first pipe between a gate of the enabled first telecom bundle and a gate of the modem.

6. The method of claim 5, wherein the gate of the modem is connected to the first baseband.

7. The method of claim 6, further comprising generating a second pipe between a gate of a second telecom bundle of the smart secure platform and a second gate of the modem, wherein the second gate of the modem is different from the gate of the modem connected to the first baseband.

8. The method of claim 6, wherein the gate of the modem is connected to a plurality of basebands comprising the first baseband through a multiplexer, each of the plurality of basebands being associated with a single SIM port.

9. The method of claim 8, further comprising generating a second pipe between a gate of a second telecom bundle of the smart secure platform and the gate of the modem connected to the first baseband.

10. The method of claim 1, wherein the first pipe is an application protocol data unit (APDU) for an APDU communication.

11. The method of claim 5, wherein the gate of the enabled first telecom bundle is a universal integrated circuit card (UICC) service gate and a gate of the modem is an UICC application gate.

12. A terminal comprising a smart secure platform, the terminal comprising:
a transceiver; and
a controller operably connected to the transceiver, the controller configured to :
enable a first telecom bundle of a plurality of telecom bundles of the smart secure platform,
generate a first pipe for a communication between the enabled first telecom bundle and a modem of the terminal, and
map the generated first pipe to a first subscriber identity module (SIM) port of a plurality of SIM ports of the modem based on an identifier of the first SIM port,
wherein the first SIM port is associated with a first baseband.

13. The terminal of claim 12, wherein the controller is further configured to control the transceiver to transmit, by a local bundle assistant (LBA) of the terminal, a bundle enablement command comprising an identifier of the enabled first telecom bundle to a secondary platform bundle load (SPBL) of the smart secure platform.

14. The terminal of claim 13, wherein the controller is further configured to control the transceiver to transmit, by the LBA, a mapping request for mapping the generated first pipe to the first SIM port of the modem, and
wherein the mapping request comprises the identifier of the first SIM port and an identifier of the first pipe.

15. The terminal of claim 13, wherein the controller is further configured to control the transceiver to transmit, by the SPBL, a mapping request for mapping the generated first pipe to the first SIM port to the modem, and wherein the bundle enablement command further comprises the identifier of the first SIM port.

16. The terminal of claim 12, wherein the controller is further configured to generate, based on a predetermined configuration, the first pipe between a gate of the enabled first telecom bundle and a gate of the modem.

17. The terminal of claim 16, wherein the gate of the modem is connected to the first baseband, and
wherein the controller is further configured to generate a second pipe between a gate of a second telecom bundle of the smart secure platform and a second gate of the modem, the second gate of the modem being different from the gate of the modem connected to the first baseband.

18. The terminal of claim 16, wherein the gate of the modem is connected to a plurality of basebands comprising the first baseband through a multiplexer, each of the plurality of basebands being associated with a single SIM port, and
wherein the controller is further configured to generate a second pipe between a gate of a second telecom bundle of the smart secure platform and the gate of the modem connected to the first baseband.

19. The terminal of claim 12, wherein the first pipe is an application protocol data unit (APDU) for an APDU communication.

20. The terminal of claim 16, wherein the gate of the enabled first telecom bundle is a universal integrated circuit card (UICC) service gate and a gate of modem is an UICC application gate.
